(19) United States
(12) Patent Application Publication
(10) Pub. No.: US 2026/0153108 A1
(43) Pub. Date: Jun. 4, 2026

(54) Frame Attachment Assembly and Method of Attachment

(71) Applicant: Instagrid GmbH, Ludwigsburg (DE)

(72) Inventors: Ömer Burak Coban, Bietigheim-Bissingen (DE); Felix Fuchs, Überlingen (DE); Robert Riegraf, Ludwigsburg (DE)

(21) Appl. No.: 18/965,210

(22) Filed: Dec. 2, 2024

(51) Int. Cl. F16B 7/18

(52) U.S. Cl. CPC F16B 7/18

(57) ABSTRACT

A frame attachment assembly includes a hollow element, and a bracket configured to be inserted into the hollow element. The bracket includes an elongated body extending between a first end and a second end, a first plate element positioned at the first end, the first plate element having an aperture configured to receive a first fastener, and a second plate element positioned at the second end, the second plate element having an aperture configured to receive a fastener. The bracket, when inserted into the hollow element, is configured to secure the hollow element between a first and second frame member by securing the first plate element to the first frame member by the first fastener and securing the second plate element to the second frame member by the second fastener.

### BACKGROUND

### Field Of The Disclosure

The present disclosure is directed to frame attachment assemblies and methods of attachment, and more specifically, to devices, assemblies, and methods for attaching hollow frame components to other frame components to form frame structures.

### Description of Related Art

A frame is a structure or structural system that is used to support other components of a physical apparatus such as a device, system, appliance, vehicle, building, or the like. Frames are constructed of various parts and components and are generally utilized across multiple industries for various applications. Certain frame types, materials, and components may be more suitable for certain applications than for others. For example, in applications such as in vehicles and household appliances, frames may be constructed from metal frame members that are fastened via fasteners such as nuts, bolts, screws, or the like. In some applications, frame members may be attached by another means such as by an adhesive or an adhesion process (e.g., welding). Regardless of the application, the attachment between various frame members impacts the function and performance of the frame for its intended application. Choosing the means or devices for the attachment between various frame components poses cost and design considerations.

In some applications, hollow components are utilized as frame members. Depending on the intended application of the frame, hollow frame components have advantages of providing necessary shape and strength at a relatively low cost and weight as compared with solid frame components of the same size and shape. However, due to the nature of a hollow frame component, which may include one or more open ends, options for fastening other frame components thereto are more limited.

Solutions for attaching hollow frame components to form a frame generally includes some type of material adhesion. For example, one solution is to directly adhere at least some components such as directly welding, soldering, or pressing metal hollow frame components with other frame components, and directly adhering some other attachment means to the end of the hollow frame component. With reference to FIG. 1, FIG. 1 is a perspective sectional view of an existing solution for attaching a hollow frame member to other frame members. In some applications, as shown in FIG. 1, attachment means are provided for a hollow frame component 10 by physically or chemically adhering one or more first fasteners 12 into the open ends 14a, 14b of the hollow frame component 10. The physical or chemical adhesion of the first fasteners 12 to the open ends 14a, 14b is commonly achieved by welding or pressing. As shown in FIG. 1, the one or more first fasteners 12 provide an interface to which another fastener, such as one or more fasteners 16, may engage. In the example shown in FIG. 1, the first fasteners 12 are nuts and the second fasteners 16 are bolts or screws. This configuration allows other frame members 18 to be attached to the hollow frame component 10 by mechanically fastening the second fasteners 16 through a portion of the other frame members 18 to the first fasteners 12 welded to the open ends 14a, 14b. However, unless done properly, attachment achieved by physical and chemical adhesion processes may be suboptimal and/or weaken over time and can lead to failure of the attachment, which leads to issues with diminished strength, integrity, and reliability of the frame. Further, any attachment solution that requires adhesion also requires additional time and cost associated with the additional manufacturing processes.

### SUMMARY

Accordingly, aspects of the present disclosure are directed to non-limiting embodiments of devices, assemblies, and methods for attaching hollow frame components to other frame components.

According to one non-limiting embodiment or aspect of the disclosure, a frame attachment assembly includes a hollow element, and a bracket configured to be inserted into the hollow element. The bracket includes an elongated body extending between a first end and a second end, a first plate element positioned at the first end, the first plate element having an aperture configured to receive a first fastener, and a second plate element positioned at the second end, the second plate element having an aperture configured to receive a fastener. The bracket, when inserted into the hollow element, is configured to secure the hollow element between a first and second frame member by securing the first plate element to the first frame member by the first fastener and securing the second plate element to the second frame member by the second fastener.

In some non-limiting embodiments, the first plate element and the second plate element extend from the elongated body substantially perpendicular to the elongated body and parallel to one another, such that an outer surface of the first plate element and an outer surface of the second plate element face opposite directions, and an inner surface of the first plate element and an inner surface of the second plate element face each other.

In some non-limiting embodiments, the hollow element includes an elongated hollow body extending between a first end and a second end, and when the bracket is inserted into the hollow element, the first plate element is substantially aligned with the first end of the hollow element, and the second plate element is substantially aligned with the second end of the hollow element.

In some non-limiting embodiments, when the bracket is inserted into the hollow element, an outer surface of the first plate element is substantially aligned with the first end of the hollow element, and an outer surface of the second plate element is substantially aligned with the second end of the hollow element.

In some non-limiting embodiments, when the bracket is inserted into the hollow element, the hollow element has at least one surface configured to engage with a complementary surface of the first or second plate element to prevent the bracket from rotating within the hollow element.

In some non-limiting embodiments, the hollow element is cylindrical, and at least one of the first plate element and the second plate element includes at least one rounded portion configured to engage with a radial inner surface of the cylindrical hollow element such that when the bracket is inserted into the hollow element, the at least one rounded portion engages the radial inner surface of the cylindrical hollow element.

In some non-limiting embodiments, the first plate element includes a tongue extending radially from a circumferential edge of the first plate element and the hollow element includes a notch configured to receive the tongue.

In some non-limiting embodiments, the second plate element includes a tongue extending radially from a circumferential edge of the second plate element and the hollow element includes a second notch configured to receive the tongue of the second plate element.

In some non-limiting embodiments, the first plate element includes a notch on a circumferential edge of the first plate element and the hollow element includes a tongue configured to be received in the notch.

In some non-limiting embodiments, the second plate element includes a notch on a circumferential edge of the second plate element and the hollow element includes a second tongue configured to be received in the notch of the second plate element.

In some non-limiting embodiments, the elongated body includes a first elbow at the first end of the bracket and a second elbow at the second end of the bracket, and the first plate element extends from the first elbow and the second plate element extends from the second elbow.

In some non-limiting embodiments, the bracket is a monolithic piece of sheet metal.

In some non-limiting embodiments, the first aperture and the second aperture are threaded and configured to receive a threaded fastener.

In some non-limiting embodiments, the first plate element and the second plate element are rigidly attached to the elongated body of the bracket.

In some non-limiting embodiments, the hollow element includes one or more protrusions extending axially from a first end of the hollow element, where the one or more protrusions are configured to engage with a complementary surface of the first frame member to prevent rotation of the hollow element relative to the first frame member.

According to another non-limiting embodiment or aspect of the disclosure, a frame includes a first frame member and a second frame member, a hollow element secured between the first frame member and the second frame member, a bracket received within the hollow element and securing the hollow element between the first frame member and the second frame member. The bracket includes an elongated body extending between a first end and a second end, a first plate element positioned at the first end, the first plate element having a first aperture configured to receive a first fastener, and a second plate element positioned at the second end, the second plate element comprising a second aperture configured to receive a second fastener. The first plate element is secured to the first frame member by a first fastener extending through a portion of the first frame member and engaging the first aperture of the first plate element.

In some non-limiting embodiments, the second plate element is secured to the second frame member by a second fastener extending through a portion of the second frame member and engaging the second aperture of the second plate element.

In some non-limiting embodiments, the first frame member and the second frame member are substantially parallel to one another and the hollow element is substantially perpendicular to the first and second frame members.

In some non-limiting embodiments, the hollow element has at least one surface configured to engage with a complementary surface of the first or second plate element to prevent the bracket from rotating within the hollow element.

In some non-limiting embodiments, the first plate element includes a tongue extending radially from a circumferential edge of the first plate element and the hollow element includes a notch configured to receive the tongue. In some non-limiting embodiments, the second plate element includes a tongue extending radially from a circumferential edge of the second plate element and the hollow element includes a second notch configured to receive the tongue of the second plate element.

According to another non-limiting embodiment or aspect of the disclosure, a method of assembling a frame includes inserting a bracket into a hollow element. The bracket includes an elongated body extending between a first end and a second end, a first plate element positioned at the first end, the first plate element comprising a first aperture configured to receive a first fastener, and a second plate element positioned at the second end, the second plate element comprising a second aperture configured to receive a second fastener. The method further includes positioning the hollow element, with the bracket inserted, between a first frame member and a second frame member, securing the bracket to the first frame member and the second frame member by positioning a first fastener through a portion of the first frame member and engaging the first fastener with the first aperture, and positioning a second fastener through a portion of the second frame member and engaging the second fastener with the second aperture.

In some non-limiting embodiments, the first frame member and the second frame member are substantially parallel to one another, and positioning the hollow element, with the bracket inserted, between the first frame member and the second frame member includes positioning the hollow element substantially perpendicular to the first and second frame members.

Further details and advantages of the various examples described in detail herein will become clear upon reviewing the following detailed description of the various examples in conjunction with the accompanying drawing figures.

### BRIEF DESCRIPTION OF THE DRAWINGS

Additional advantages and details are explained in greater detail below with reference to the example embodiments that are illustrated in the accompanying schematic figures, in which:

FIG. 1 is a perspective sectional view of an existing solution for attaching a hollow frame member to other frame members;

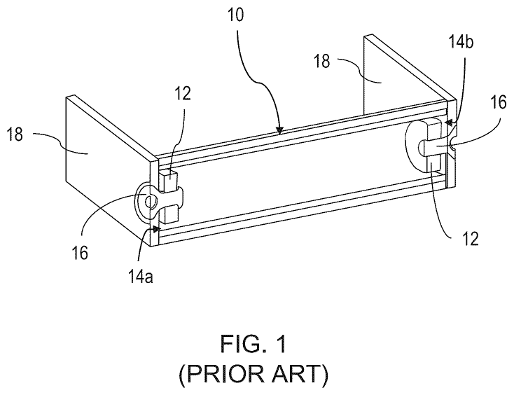

FIGS. 2A-2C are perspective views of a non-limiting embodiment of a frame attachment assembly in accordance with the present disclosure;

FIGS. 3A-3C are perspective and side views of a non-limiting embodiment of a bracket of a frame attachment assembly in accordance with the present disclosure;

FIGS. 4A-4C are perspective and side views of a non-limiting embodiment of a hollow element of a frame attachment assembly in accordance with the present disclosure;

FIGS. 5A-5B are perspective sectional and detail views of a non-limiting embodiment of a frame having a frame attachment assembly in accordance with the present disclosure; and

FIG. 6 is a perspective view of a non-limiting embodiment of a frame having a frame attachment assembly in accordance with the present disclosure.

Corresponding reference characters indicate corresponding parts throughout the several views. The exemplifications set out herein illustrate non-limiting embodiments or aspects of the disclosure, and such embodiment or aspects are not to be construed as limiting the scope of the disclosure in any manner.

### DETAILED DESCRIPTION

For purposes of the description hereinafter, special and directional terms such as “end”, “upper”, “lower”, “right”, “left”, “vertical”, “horizontal”, “top”, “bottom”, “lateral”, “longitudinal”, and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting example embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one”. As used in the specification and the claims, the singular form of “a”, “an”, and “the” include plural referents, such as unless the context clearly dictates otherwise. Where only one item is intended, the term “one” or similar language is used. The term “at least” is synonymous with “greater than or equal to”. The term “includes” is synonymous with “comprises”. Also, as used herein, the terms “has”, “have”, “having”, or the like are intended to be open-ended terms. The terms “first”, “second”, and the like are not intended to refer to any particular order or chronology, but refer to different conditions, properties, or elements. Further, the phrase “based on” is intended to mean “based at least partially on” unless explicitly stated otherwise.

All numbers and ranges used in the specification and claims are to be understood as being modified in all instances by the term “about”. By “about” is meant plus or minus twenty-five percent of the stated value. However, this should not be considered as limiting to any analysis of the values under the doctrine of equivalents. Unless otherwise indicated, all ranges disclosed herein are to be understood to encompass the beginning and ending values and any and all subranges subsumed therein. For example, a stated range of “1 to 10” should be considered to include any and all subranges between (and inclusive of) the minimum value of 1 and the maximum value of 10; that is, all subranges or beginning with a minimum value of 1 or more and ending with a maximum value of 10 or less. The ranges disclosed herein represent the average values over the specified range.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Non-limiting embodiments of the present disclosure are generally directed to a frame attachment assembly which may include a hollow element and a bracket configured to be inserted into the hollow element. The bracket may include an elongated body extending between a first end and a second end, a first plate element positioned at the first end having an aperture for receiving a fastener, and a second plate element positioned at the second end having an aperture for receiving a fastener. The bracket, when inserted into the hollow element, may be configured to secure the hollow element between a first and second frame member by securing the first plate element to the first frame member by the first fastener and securing the second plate element to the second frame member by the second fastener.

Non-limiting and example embodiments of devices, assemblies, and methods for attaching hollow frame components to other frame components according to the present disclosure will now be described with reference to the appended drawings in which corresponding reference characters indicate corresponding parts throughout the several views.

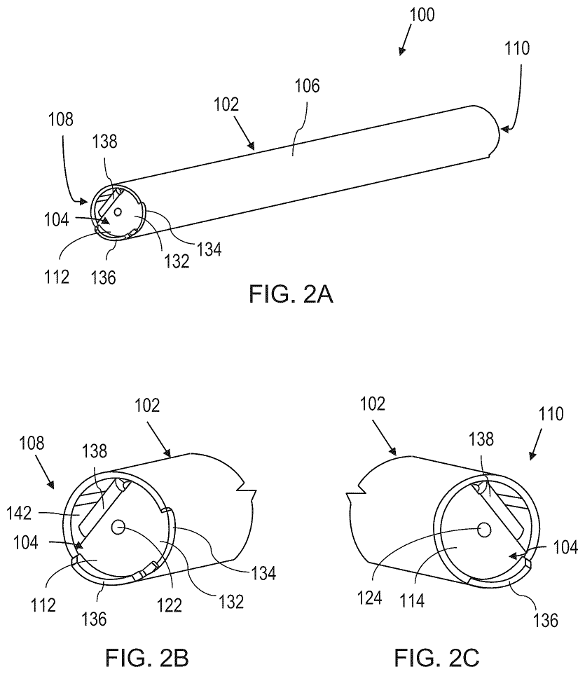

Referring now to FIGS. 2A-2C, FIGS. 2A-2C are perspective views of a non-limiting embodiment of frame attachment assembly 100 in accordance with the present disclosure. As shown in FIG. 2A, frame attachment assembly 100 may include hollow element 102 and bracket 104. Bracket 104 may be configured to be inserted into hollow element 102. In some example embodiments, hollow element 102 may be a tube, such as a tubular length of material (e.g., plastic, metal, ceramic, carbon fiber, or wood) used as a structural member in a frame. In some non-limiting embodiments, hollow element 102 may include an elongated hollow body 106 extending between a first end 108 and a second end 110. First end 108 and second end 110 may each be open or, in some non-limiting embodiments, one of first end 108 and second end 110 may be at least partially closed via an integral or removable end cap.

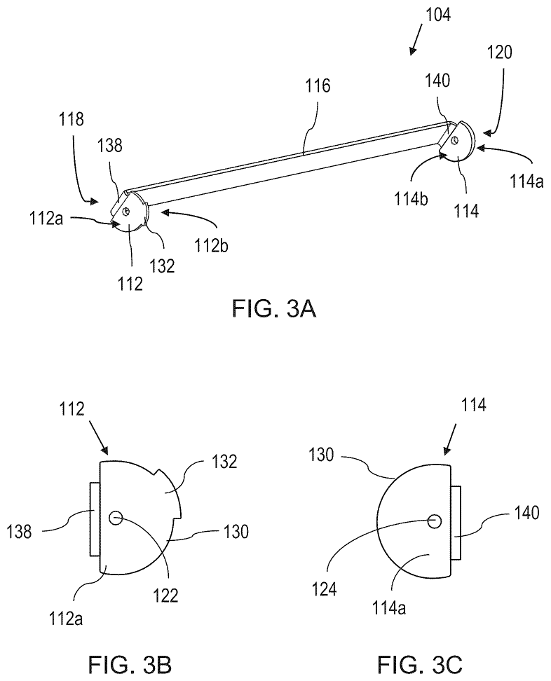

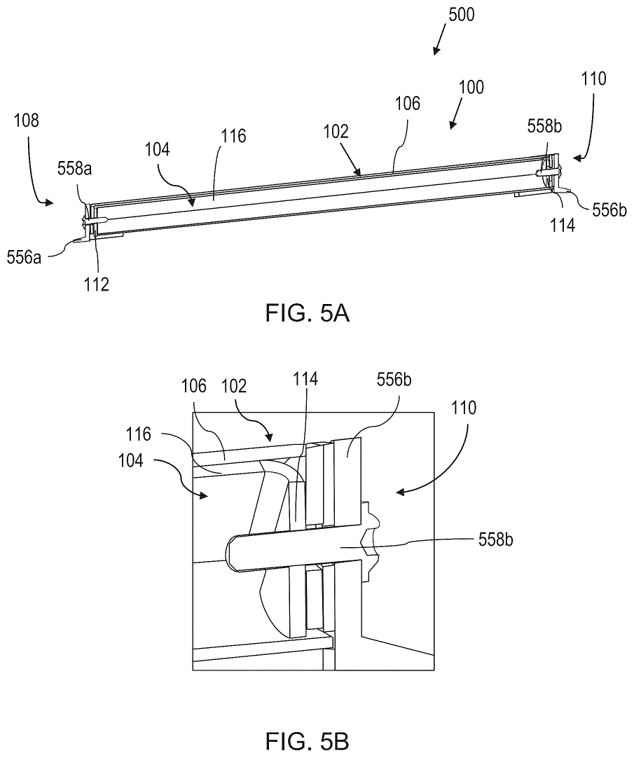

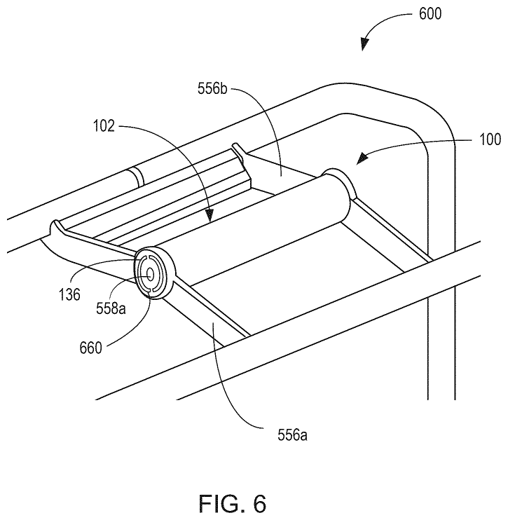

As further shown in FIGS. 2A-2C and with additional reference to FIG. 3A, bracket 104 may include first plate element 112, second plate element 114, and elongated body 116 extending between first end 118 of bracket 104 and second end 120 of bracket 104. First plate element 112 may be positioned at first end 118 of bracket 104, and second plate element 114 may be positioned at second end 120 of bracket 104. First plate element 112 and/or second plate element 114 may be rigidly connected (including through an integral connection) to elongated body 116 such that first plate element 112 and/or second plate element 114 are not movable (e.g., are not pivotable or rotatable) relative to elongated body 116. Each of first plate element 112 and second plate element 114 may include an aperture or opening for receiving a fastener (e.g., fasteners 558a, 558b shown in FIGS. 5A-6 and described below). For example, as shown in FIGS. 2A-2C and FIGS. 3A-3C, first plate element 112 may include first aperture 122 and second plate element 114 may include second aperture 124.

In some non-limiting embodiments, first aperture 122 and second aperture 124 may be configured to receive a fastener via threaded engagement. For example, first aperture 122 and second aperture 124 may be threaded and may be configured to receive a threaded fastener such as a bolt, a screw, or the like. In some non-limiting embodiments, first aperture 122 and second aperture 124 may not be threaded but may nonetheless be configured to receive a fastener. For example, first aperture 122 and second aperture 124 may be appropriately sized to receive a self-tapping or self-drilling fastener, such as a sheet metal screw. In still other embodiments, first plate element 112 and second plate element 114 may not include an aperture but may instead have an area of its surface that is sufficiently thin or weakened (including through, e.g., half-shearing) so that it can be penetrated by way of a fastener, such as a nail, bolt, screw, or the like.

With continued reference to FIGS. 2A-2C, bracket 104 can be inserted into hollow element 102. This can be done by inserting bracket 104 into an open end (e.g., first end 108) of hollow element 102 such that all, or substantially all, of bracket 104 is contained within hollow element 102. In some non-limiting embodiments, second plate element 114 has an outer dimension (e.g., circumference) that is smaller than the inner dimension (e.g., circumference) of hollow element 102 to allow second plate element 114 to freely slide through hollow element 102. As will be described further below, first plate element 112 may have an outer circumference (or at least a portion thereof) that is larger than the inner circumference of hollow element 102 to prevent first plate element 112 from completely entering into hollow element 102 and thereby preventing bracket 104 from sliding completely through hollow element 102. In some non-limiting embodiments, second end 110 of hollow element 102 can include an end cap that at least partially covers second end 110. In this embodiment, when the bracket 104 is inserted into hollow element 102, second plate element 114 can contact the end cap to prevent further movement of bracket 104.

Referring now to FIGS. 3A-3C, FIGS. 3A-3C are perspective and side views of a non-limiting embodiment of bracket 104 of frame attachment assembly 100 in accordance with the present disclosure. As shown in FIG. 3A, bracket 104 may include elongated body 116 extending between first end 118 and second end 120 of bracket 104. As further shown in FIG. 3A, in some non-limiting embodiments, first plate element 112 and second plate element 114 may extend from elongated body 116 substantially perpendicular to elongated body 116 and parallel to one another, such that outer surface 112a of first plate element 112 and outer surface 114a of second plate element 114 may face opposite directions. Similarly, inner surface 112b of first plate element 112 and inner surface 114b of second plate element 114 may face each other.

With continued reference to FIGS. 3A-3C, in some non-limiting embodiments, elongated body 116 may include first elbow 138 at first end 118 of bracket 104 and second elbow 140 at second end 120 of bracket 104. In some non-limiting embodiments, first plate element 112 may extend from first elbow 138 and second plate element 114 may extend from second elbow 138. In some non-limiting embodiments, elbows 138, 140 may determine the angle of connection between first plate element 112 and elongated body 116, and between second plate element 114 and elongated body 116. For example, as shown in FIG. 3A, elbows 138, 140 may be 90-degree elbows such that first plate element 112 and second plate element 114 are substantially perpendicular to elongated body 116 and parallel to one another.

However, it is also considered that elbows 138, 140 may be configured to hold (e.g., rigidly hold) first plate element 112 and second plate element 114 at any advantageous angle with respect to elongated body 116 and/or with each other. For example, where elongated body 116 is curved or includes an angle, it may be advantageous for first plate element 112 and second plate element 114 to be held at an angle other than 90 degrees with respect to elongated body 116 such that first plate element 112 and second plate element 114 are still substantially parallel to each other. In another example embodiment, where elongated body 116 is curved or includes an angle, it may be advantageous for first plate element 112 and second plate element 114 to each be held at an angle with respect to elongated body 116 such that first plate element 112 and second plate element 114 are each held substantially at 90 degrees with respect to the elongated body instead of parallel to each other. Such configurations may be necessary and/or advantageous, for instance, to allow the shape of bracket 104 to correspond with the shape of hollow element 102 where hollow element 102 is not a straight hollow segment.

In some non-limiting embodiments, bracket 104 may be a monolithic piece of metal, such as sheet metal. For example, bracket 104 may be punched from a sheet of metal, such as aluminum, steel, or the like. First plate element 112 and second plate element 114 may then be bent with respect to elongated body 116 to form elbows 138, 140. In some non-limiting embodiments, the thickness of the sheet metal is sufficient to impart rigidity to bracket 104, including the connection between elongated body 116 and each of first and second plate elements 112, 114. For example, elbows 138, 140 can be sufficiently thick and/or strong to prevent pivoting or rotating of first and second plate elements 112, 114 relative to elongated body 116. In other non-limiting embodiments, first plate element 112 and/or second plate element 114 may be formed separately from elongated body 116 and then may be affixed, such as by welding, to elongated body 116. Such connection (e.g., a weld joint) can have sufficient strength to prevent pivoting or rotating of first and second plate elements 112, 114 relative to elongated body 116.

In another non-limiting embodiments, elongated body 116 may be formed as separate pieces, including a first piece that includes first plate element 112 and a portion of elongated body 116 and a second piece that includes second plate element 114 and the remainder of elongated body 116. The first and second pieces can be connected along the length of elongated body 116 through an interlocking connection such as a press fit, threaded, tongue-and-groove or other connection mechanism. In this embodiment, bracket 104 can be assembled within hollow element 102 by inserting a first portion of bracket 104 (e.g., that includes first plate member 112 and a portion of elongated body 116) through first end 108 of hollow element 102, inserting a second portion of bracket 104 (e.g., that includes second plate element 114 and a portion of elongated body 116) through second end 110 of elongated body 106), and connecting together the portions of elongated body 116 to form bracket 104.

Apertures 122, 124 may be punched from or drilled into first plate element 112 and second plate element 114. In embodiments where apertures 122, 124 are configured for threaded engagement, apertures 122, 124, may then be tapped to form threads with which to engage a threaded fastener. As mentioned above, in some non-limiting embodiments, first and second plate elements 112, 114 may not have pre-formed apertures but may instead include a thinner or weakened portion (e.g., through half-shearing) through which a fastener can easily penetrate.

In some non-limiting embodiments, bracket 104 has a length that substantially corresponds to the length of hollow element 102. For example, in some non-limiting embodiments, when bracket 104 is inserted into hollow element 102, first plate element 112 may be substantially aligned with first end 108 of hollow element 102 and second plate element 114 may be substantially aligned with second end 110 of hollow element 102. In some non-limiting embodiments, when bracket 104 is inserted into hollow element 102, outer surface 112a of first plate element 112 may be substantially aligned with (e.g., flush with or substantially flush with) first end 108 of hollow element 102 and outer surface 114a of second plate element 114 may be substantially aligned with (e.g., flush with or substantially flush with) second end 110 of hollow element 102. This configuration may allow frame attachment assembly 100 to be positioned in close proximity to and/or contact adjacent frame members such that first end 108 and second end 110 of hollow element 102 are simultaneously flush with the respective frame elements, as shown in FIGS. 5A and 6.

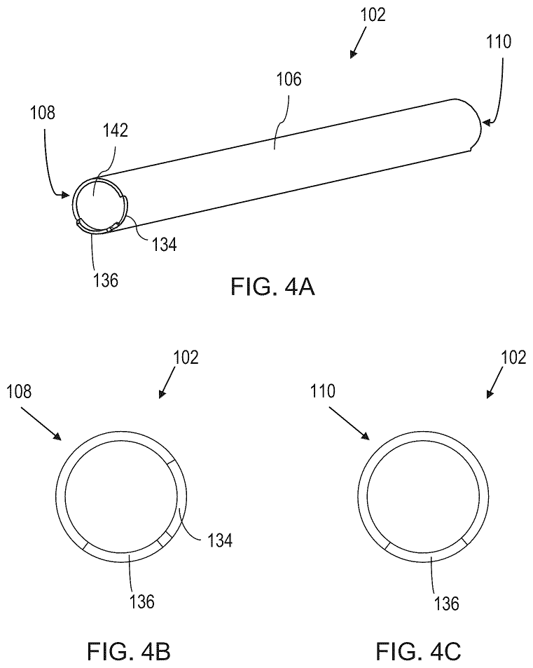

Referring now to FIGS. 4A-4C, FIGS. 4A-4C are perspective and side views of a non-limiting embodiment of hollow element 102 of frame attachment assembly 100 in accordance with the present disclosure. In some non-limiting embodiments, when bracket 104 is inserted into hollow element 102, hollow element 102 may include at least one surface configured to engage with a complementary surface of first plate element 112 or second plate element 114 to prevent bracket 104 from rotating within hollow element 104. In some non-limiting embodiments, the shape of the inner hollow portion 142 of hollow element 102 may correspond to the shape of first plate element 112 and/or second plate element 114. For example, in some non-limiting embodiments, first plate element 112 and/or second plate element 114 may be square, triangular, hexagonal, octagonal, or any other shape that is irregular or includes angles, and the shape of inner hollow portion 142 of hollow element 102 may correspond to the shape of first plate element 112 and/or second plate element 114. In such embodiments, the corresponding shapes of inner hollow portion 142 and first plate element 112 and/or second plate element 114 may engage and prevent rotation of bracket 104 within hollow 102. In some non-limiting embodiments, the outer (e.g., exterior) profile or shape of the elongated body 106 of hollow element 102 may correspond to the shape of inner hollow portion 142, or it may be different. For example, inner hollow portion 142 may be square while the outer profile of the elongated body 106 may be circular (e.g., cylindrical). A cylindrical outer profile, such as is shown in FIGS. 4A and 6, may be advantageous if, for example, hollow element 102 is to act as a handle or other frame element that is intended to be grasped by a user. However, the outer profile of hollow element 102 may take on another cross-sectional shape, such as rectangular, square, oval, or triangular. In addition, as mentioned above, hollow element 102 may be straight along its axial length, as shown in FIG. 4A, or it may be curved.

In some non-limiting embodiments, as shown in FIGS. 4A-4C, hollow element 102 may be cylindrical such that both inner hollow portion 142 and the outer profile of the elongated body 106 comprise circular cross sections. In some non-limiting embodiments, as shown in FIGS. 3A-3C, at least one of first plate element 112 and second plate element 114 may include at least one rounded portion 130 configured to engage with a radial inner surface of cylindrical hollow element 102, such as with inner hollow portion 142. In some non-limiting embodiments, when bracket 104 is inserted into hollow element 102, at least one rounded portion 130 engages inner hollow 142 or the radial inner surface of the cylindrical hollow element 102 (e.g., as shown in FIGS. 2A-2C) to guide bracket 104 within hollow element 106 and prevent radial movement of bracket 104 relative to hollow element 102. Hollow element 102 may include one or more protrusions 136 extending from first end 108 and/or second end 110 of hollow element 102. In some non-limiting embodiments, protrusion 136 may extend axially from first end 108 and/or second end 110, such that protrusion 136 extends from a lip or a rim at an end of elongated body 106 of hollow element 102. As will be described further below, the protrusions 136 can engage with complementary openings or recesses on a frame to help secure hollow element 102 to the frame.

With reference to FIGS. 2A-4C, in some non-limiting embodiments, first plate element 112 may include tongue 132 extending radially from a circumferential edge of first plate element 112 and hollow element 102 may include notch 134, such as a notch at the first end 108, configured to receive or engage with tongue 132. For example, tongue 132 may seat within notch 134 so as to allow first plate member 112 to rest flush, or substantially flush, with first end 108 of hollow element 102, as shown in FIG. 2B. In some non-limiting embodiments, second plate element 114 may also or instead include a tongue (not shown, but similar to tongue 132) extending radially from a circumferential edge of second plate element 114 and hollow element 102 may include a second notch (not shown, but similar to notch 134), such as at second end 110, and the second notch may be configured to receive the tongue of second plate element 114. An embodiment in which both the first plate element 112 and second plate element 114 include a tongue may be used in conjunction with the embodiment discussed above in which the elongated body 116 of bracket 104 is composed of multiple pieces that are connected together within hollow element 102.

In some non-limiting embodiments, first plate element 112 may include a notch on a circumferential edge of first plate element 112 and hollow element 102 may include a tongue, such as at first end 108, and the tongue of first hollow element 102 may be configured to be received in the notch of first plate element 112. In some non-limiting embodiments, second plate element 114 may also or instead include a notch on a circumferential edge of second plate element 114 and hollow element 102 may include a second tongue, such as at second end 110, and the second tongue may be configured to be received in the notch of second plate element 114.

The engagement between one or more tongues and one or more notches may prevent bracket 104 from rotating within hollow element 102 when bracket 104 is inserted into hollow element 102, such as when frame attachment assembly 100 is used to secure frame members at first end 108 and/or second end 110. For example, when tongue 132 is engaged with notch 134 (such as when tongue 132 is seated within notch 134), this engagement can prevent bracket 104 from rotating within hollow element 102 since the notch 134 restricts rotational movement of tongue 132.

Referring now to FIGS. 5A-5B, FIGS. 5A-5B are perspective sectional and detail views of a non-limiting embodiment of frame 500 in accordance with the present disclosure. As shown in FIG. 5A, frame 500 may include a frame attachment assembly that may be the same as or similar to frame attachment assembly 100, or frame 500 may include components thereof, where like parts are referred to with like reference numerals. Frame 500 may include first frame member 556a and second frame member 556b. Frame 500 may further include a hollow element (e.g., hollow element 102) between first frame member 556a and second frame member 556b. In some non-limiting embodiments, first and second frame members 556a, 556b may be positioned on opposite ends of the hollow element. Frame 500 may further include a bracket (e.g., bracket 104) received within the hollow element. The bracket may include an elongated body (e.g., elongated body 116) extending between a first end (e.g., first end 108) and a second end (e.g., second end 110). The bracket may further include a first plate element (e.g., plate element 112) positioned at the first end and the first plate element may include a first aperture (e.g., first aperture 122). The first aperture may be configured to receive first fastener 558a. Frame 500 may further include a second plate element (e.g., second plate element 114) positioned at the second end, and the second plate element may include a second aperture (e.g., second aperture 124), which may be configured to receive second fastener 558b.

The first plate element may be secured to first frame member 556a by first fastener 558a extending through a portion of first frame member 556a and engaging the first aperture of the first plate element. In some non-limiting embodiments, the second plate element may be secured to second frame member 556b by second fastener 558b extending through a portion of second frame member 556b and engaging the second aperture of the second plate element.

Referring now to FIG. 6, FIG. 6 is a perspective view of a non-limiting embodiment of frame 600 in accordance with the present disclosure. As shown in FIG. 6, frame 600 may be the same as or similar to frame 500 and may include a frame attachment assembly that may be the same as or similar to frame attachment assembly 100 or components thereof, where like parts are referred to with like reference numerals. In some non-limiting embodiments, as shown in FIG. 6, a hollow element (e.g., hollow element 102) of frame 600 may include at least one engagement surface configured to engage with a complementary surface of the first or second frame member (e.g., first frame member 556a, second frame member 556b) to prevent the hollow element from rotating within respect to the first and/or second frame member. For example, as shown in FIGS. 2A-2C and 4A-4C and discussed above, hollow element 102 may include one or more protrusions 136 extending from first end 108 and/or second end 110 of hollow element 102, such as protrusions 136 that extend axially from a lip or a rim at an end of elongated body 106 of hollow element 102. In some example embodiments, the engagement surface, such as protrusion 136, may be configured to engage a recess or opening (e.g., recess 660) of the first and/or second frame member. The engagement between the engagement surface of the hollow element and the complementary surface of the first or second frame member may prevent the hollow element from rotating with respect to the first and/or second frame member. The hollow element 102 of FIG. 6 may function as a handle that can be grasped by a user.

In some non-limiting embodiments, as shown in FIG. 6, first frame member 556a and second frame member 556b may be substantially parallel to one another and the hollow element may be substantially perpendicular to first frame member 556a and second frame member 556b. In some non-limiting embodiments, first frame member 556a and second frame member 556b may be held at an angle with respect to one another, and/or with respect to the hollow element, depending on the intended use of the frame.

According to another aspect of the disclosure, a method of assembling a frame may include inserting a bracket into a hollow element. For example, the bracket may be the same as or similar to bracket 104. Similarly, for example, the hollow element may be the same as or similar to hollow element 102. In example embodiments, the bracket may include an elongated body (e.g., elongated body 116) extending between a first end (e.g., first end 118) and a second end (e.g., second end 120), a first plate element (e.g., first plate element 112) positioned at the first end, the first plate element including a first aperture (e.g., first aperture 122) configured to receive a first fastener (e.g., first fastener 558a), and a second plate element (e.g., second plate element 114) positioned at the second end, the second plate element including a second aperture (e.g., second aperture 124) configured to receive a second fastener (e.g., second fastener 558b). The method may further include positioning the hollow element, with the bracket inserted, between a first frame member (e.g., first frame member 556a) and a second frame member (e.g., second frame member 556b), securing the bracket to the first frame member and the second frame member by positioning a first fastener through a portion of the first frame member and engaging the first fastener with the first aperture, and positioning a second fastener through a portion of the second frame member and engaging the second fastener with the second aperture.

In some non-limiting embodiments, the first frame member and second frame member may be substantially parallel to one another. In some non-limiting embodiments, when positioning the hollow element, with the bracket inserted, between the fist frame member and the second frame member, the method may further include positioning the hollow element substantially perpendicular to the first and second frame members. In some non-limiting embodiments, when positioning the bracket in the hollow element, the method may further include aligning at least one surface of the hollow element configured to engage with a complementary surface of the first or second frame member with said complementary surface of the first or second plate element to prevent the bracket from rotating within the hollow element. For example, the method may include aligning and engaging one or more protrusions (e.g., protrusions 136) of the hollow member with corresponding recesses (e.g., recesses 660) of the first and second frame members.

Although the devices, assemblies, and methods of the present disclosure have been shown in the accompanying figures and described in detail hereinabove with reference to attaching hollow frame components to other frame components, it is to be understood that embodiments of the devices, assemblies, and methods are also suitable for other applications such as for attaching various components to form various structures other than those described herein.

While the several examples of the systems and methods for attaching hollow frame components to other frame components have been shown in the accompanying figures and described in detail hereinabove, other aspects will be apparent to and readily made by those skilled in the art without departing from the scope and spirit of the disclosure. Accordingly, the foregoing description is intended to be illustrative rather than restrictive. The disclosure provided hereinabove is defined by the appended claims and all changes to the example non-limiting embodiments that fall within the meaning and range of equivalency of the claims are to be embraced within their scope.

What is claimed is:

1. A frame attachment assembly, comprising:
a hollow element; and
a bracket configured to be inserted into the hollow element,
wherein the bracket comprises:
an elongated body extending between a first end and a second end;
a first plate element positioned at the first end, the first plate element comprising a first aperture configured to receive a first fastener; and
a second plate element positioned at the second end, the second plate element comprising a second aperture configured to receive a second fastener,
wherein the bracket, when inserted into the hollow element, is configured to secure the hollow element between a first and second frame member by securing the first plate element to the first frame member by the first fastener and securing the second plate element to the second frame member by the second fastener.

2. The frame attachment assembly of claim 1, wherein the first plate element and the second plate element extend from the elongated body substantially perpendicular to the elongated body and parallel to one another, such that an outer surface of the first plate element and an outer surface of the second plate element face opposite directions, and an inner surface of the first plate element and an inner surface of the second plate element face each other.

3. The frame attachment assembly of claim 1, wherein the hollow element comprises an elongated hollow body extending between a first end and a second end, and
wherein, when the bracket is inserted into the hollow element, the first plate element is substantially aligned with the first end of the hollow element, and the second plate element is substantially aligned with the second end of the hollow element.

4. The frame attachment assembly of claim 3, wherein, when the bracket is inserted into the hollow element, an outer surface of the first plate element is substantially aligned with the first end of the hollow element, and an outer surface of the second plate element is substantially aligned with the second end of the hollow element.

5. The frame attachment assembly of claim 1, wherein, when the bracket is inserted into the hollow element, the hollow element has at least one surface configured to engage with a complementary surface of the first or second plate element to prevent the bracket from rotating within the hollow element.

6. The frame attachment assembly of claim 1, wherein the hollow element is cylindrical, and
wherein at least one of the first plate element and the second plate element comprises at least one rounded portion configured to engage with a radial inner surface of the cylindrical hollow element such that when the bracket is inserted into the hollow element, the at least one rounded portion engages the radial inner surface of the cylindrical hollow element.

7. The frame attachment assembly of claim 1, wherein the first plate element and the second plate element are rigidly attached to the elongated body of the bracket.

8. The frame attachment assembly of claim 1, wherein the first plate element comprises a tongue extending radially from a circumferential edge of the first plate element and the hollow element comprises a notch configured to receive the tongue.

9. The frame attachment assembly of claim 1, wherein the first plate element comprises a notch on a circumferential edge of the first plate element and the hollow element comprises a tongue configured to be received in the notch.

10. The frame attachment assembly of claim 1, wherein the hollow element comprises one or more protrusions extending axially from a first end of the hollow element, wherein the one or more protrusions are configured to engage with a complementary surface of the first frame member to prevent rotation of the hollow element relative to the first frame member.

11. The frame attachment assembly of claim 1, wherein the elongated body comprises a first elbow at the first end of the bracket and a second elbow at the second end of the bracket, and
wherein the first plate element extends from the first elbow and the second plate element extends from the second elbow.

12. The frame attachment assembly of claim 1, wherein the bracket is a monolithic piece of sheet metal.

13. The frame attachment assembly of claim 1, wherein the first aperture and the second aperture are threaded and configured to receive a threaded fastener.

14. A frame, comprising:
a first frame member and a second frame member;
a hollow element secured between the first frame member and the second frame member;
a bracket received within the hollow element and securing the hollow element between the first frame member and the second frame member, wherein the bracket comprises:
an elongated body extending between a first end and a second end;
a first plate element positioned at the first end, the first plate element comprising a first aperture configured to receive a first fastener; and
a second plate element positioned at the second end, the second plate element comprising a second aperture configured to receive a second fastener;
wherein the first plate element is secured to the first frame member by a first fastener extending through a portion of the first frame member and engaging the first aperture of the first plate element.

15. The frame of claim 14, wherein the second plate element is secured to the second frame member by a second fastener extending through a portion of the second frame member and engaging the second aperture of the second plate element.

16. The frame of claim 14, wherein the first frame member and the second frame member are substantially parallel to one another and the hollow element is substantially perpendicular to the first and second frame members.

17. The frame of claim 14, wherein the hollow element has at least one surface configured to engage with a complementary surface of the first or second plate element to prevent the bracket from rotating within the hollow element.

18. The frame of claim 14, wherein the first plate element comprises a tongue extending radially from a circumferential edge of the first plate element and the hollow element comprises a notch configured to receive the tongue.

19. A method of assembling a frame, comprising:
inserting a bracket into a hollow element, wherein the bracket comprises:
an elongated body extending between a first end and a second end;
a first plate element positioned at the first end, the first plate element comprising a first aperture configured to receive a first fastener; and
a second plate element positioned at the second end, the second plate element comprising a second aperture configured to receive a second fastener,
positioning the hollow element, with the bracket inserted, between a first frame member and a second frame member;
securing the bracket to the first frame member and the second frame member by positioning a first fastener through a portion of the first frame member and engaging the first fastener with the first aperture and positioning a second fastener through a portion of the second frame member and engaging the second fastener with the second aperture.

20. The method of claim 19, wherein the first frame member and the second frame member are substantially parallel to one another, and positioning the hollow element, with the bracket inserted, between the first frame member and the second frame member comprises positioning the hollow element substantially perpendicular to the first and second frame members.
